(19) United States
(12) Patent Application Publication
(10) Pub. No.: US 2005/0042417 A1
(43) Pub. Date: Feb. 24, 2005

(54) Open network structural members

(75) Inventor: John E. Irvine, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: CMI Limited Company, Columbus, OH (US)

(21) Appl. No.: 10/645,142

(22) Filed: Aug. 21, 2003

(51) Int. Cl. B32B 3/04

(52) U.S. Cl. 428/122

(57) ABSTRACT

A reinforced structural member comprising an elongate reinforcing structure formed of high strength material defining an array of equally spaced openings therethrough. The reinforced structural member also includes an exterior body of water-impermeable material positioned about and in contact with the reinforcing structure, wherein the reinforcing structure is encapsulated within the exterior body.

### FIELD OF THE INVENTION

The present invention relates generally to extruded structural members fabricated of synthetic materials. More specifically, the present invention relates to reinforced structural members formed so as to minimize deterioration of the structural members due to exposure to the elements.

### BACKGROUND OF THE INVENTION

Structural members, such as planks, beams, sheet piles, etc., are frequently used in the construction of structures that are exposed to direct contact with damaging environmental elements. For example, foundation members such as piles are often driven into high moisture content soils where the potential for accelerated decay and subsequent weakness exists. Decay may result not only from exposure to water, but also from exposure to wood boring organisms, such as termites. Above ground structural members are also prone to accelerated decay and subsequent weakness from exposure to environmental elements, such as rain and ultraviolet radiation. Replacement of damaged and decayed structural members is both time consuming and expensive. Therefore, a need exists for structural members that resist decay caused by extended exposure to the elements, whether or not the structural member is used above or below ground.

In the past, structural members have frequently been constructed of wood and impregnated or coated with various chemicals and substances to help offset the decay of the wood. As would be expected, as those structural members eventually decay, the chemicals used to treat the wooden structural members can enter the environment in which the structural members are used. For example, the potential exists for treated wood foundation members used in constructing a pier to eventually leach the chemicals into both the body of water and the soil the foundation members extend into. As well, it is often necessary to reapply the chemicals and various coatings at repeated intervals to ensure adequate protection of the wooden structural members. Reapplication of such coatings is labor intensive and therefore costly.

An alternative to treated wood structural members is structural members constructed of metal, most frequently steel. Since most metals used in these structural members are subject to corrosion as well, those structural members must either be frequently painted or coated so as to prevent direct exposure of the metal to the environment. Also, structural members can be substantially oversized to allow for deterioration due to erosion. In either case, the cost to overcome the deterioration of the metal caused by the environment is expensive.

Another alternative is structural members constructed of polyvinyl chloride and other plastics having relatively low tensile strength and high compression strength. The plastic has a very low modulus of elasticity relative to metal. In order to achieve the strength in the (structural member) necessary to withstand the application loads, the thicknesses of the plastic structural members must be appreciably greater than an equivalent structural member made of metal. As such, there is a practical limit to the size, as well as the cost of these all plastic structural members.

Therefore, there is a need for improved structural members which address these and other shortcomings of the prior art.

### SUMMARY OF THE INVENTION

Briefly described, the present invention relates to a reinforced structural member including an elongate reinforcing structure formed of foraminous high strength material or other open network material such as expanded metal sheet material. The structural member also includes an exterior body of water-impermeable material surrounding the reinforcing structure such that the reinforcing structure is encapsulated within the exterior body and protected from engagement by moisture in the atmosphere.

The present invention also relates to a method of producing the reinforced structural members. In a preferred embodiment, the method includes the steps of: forming an elongate reinforcing structure from high strength material; extruding an exterior body of water-impermeable material adjacent the reinforcing structure such that the reinforcing structure is fully encapsulated within the exterior body. The exterior body can be formed of various plastics, such as polyvinyl chloride, wood flour, etc., that can resist deterioration from atmospheric conditions, such as changes in temperatures, extreme temperatures, liquid contact, frozen water, ultraviolet radiation, and abrasion from water, sand and the like.

Other objects, features and advantages of the present invention will become apparent upon reading the following specification, when taken in conjunction with the accompanying drawings.

### BRIEF DESCRIPTION OF THE SEVERAL VIEWS OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of a preferred embodiment of a structural member of the present invention.

FIG. 2 is a perspective fragmentary view of the structural member shown in FIG. 1, with portions broken away to illustrate the reinforcing structure and the surrounding extruded coating.

FIG. 3 is a perspective view of another preferred embodiment of a structural member of the present invention.

FIG. 4A is perspective view of another preferred embodiment of a structural member of the present invention.

FIGS. 4B and 4C are cross sectional views of the structural member similar to that shown in FIG. 4A,illustrating alternate embodiments of the reinforcing structure.

FIGS. 5A and 5B are perspective views of other preferred embodiments of structural members of the present invention, showing different shapes of the reinforcing sheet material.

FIG. 6 is a perspective view of another preferred embodiment of a structural member of the present invention.

FIGS. 7A and 7B are perspective views of other preferred embodiments of structural members of the present invention.

FIG. 8 is a flow diagram disclosing a method of producing preferred embodiments of the reinforced structural members of the present invention.

FIG. 9 is a schematic diagram of a system used to construct preferred embodiments of the reinforced structural members according to the present invention.

### DETAILED DESCRIPTION OF THE PREFERRED EMBODIMENT

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

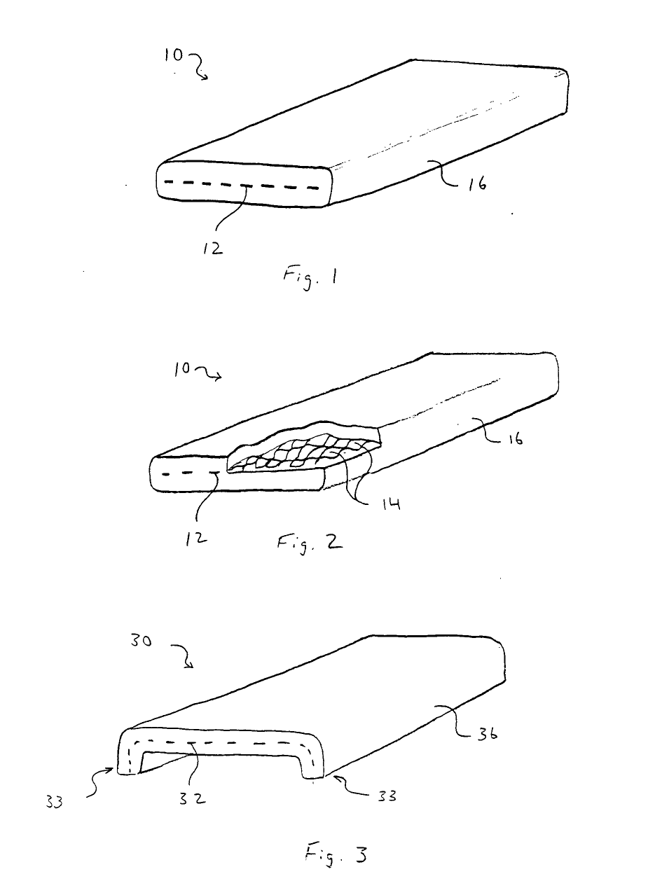

Referring now to FIG. 1, a preferred embodiment of a reinforced structural member 10 includes a reinforcing structure 12 acting as an internal support and an exterior coating or body 16 that is applied to and encapsulates the reinforcing structure 12. The placement of the reinforcing structure 12 within the exterior body 16 is represented by the dashed line. Each structural member 10 is formed of a plastic, such as polyvinyl chloride, polypropylene, polyethylene or other suitable synthetic or polymer material. Preferably, the materials chosen are strong and highly resistant to adverse weather conditions, and include properties that adequately resist abrasion from soils, resist deterioration due to ultraviolet radiation, and can withstand the bending and compressive forces normally encountered for the particular design of structural member 10 being used. As well, it may be desirable to use substances such as wood flour and plastic mixtures to obtain a wood-like appearance for the exterior body 16.

As shown in FIG. 2, the reinforcing structure 12 is formed within an array of perforations 14 (FIG. 2) formed therein. Preferably, the reinforcing structure 12 is formed with expanded metal sheet material. The expanded metal is of known construction, that includes sheet metal formed with an array of parallel, longitudinally offset slits that have been opened by lateral expansion of the sheet to form an array of perforations 14 in the sheet. Preferred embodiments are constructed of steel, galvanized steel, aluminum and like materials, having a thickness of approximately one-quarter to one-half inch. The combination of the expanded metal and exterior body is strong enough to withstand the loads applied to the structures in which the reinforced structural members are used. The reinforcing structure 12 can be formed of other materials that are compatible with the expected uses of the structural members, such as fiberglass.

As shown in FIG. 2, the reinforcing structure 12 is fully encapsulated by the exterior body 16. By fully encapsulating the reinforcing structure 12, the reinforcing structure 12 can be protected from the environmental conditions to which the structural member 10 will be subjected. Preferably, the number and size of perforations 14 are such that approximately 25% to 95% of the surface area of the reinforcing structure 12 is actually perforations 14. This allows the materials used to form the exterior body 16 to adequately flow through and make contact with all portions of the reinforcing structure 12, thereby ensuring full encapsulation. The use of expanded metal with its associated perforations 14 also permits a user to drill holes and drive fasteners into and through the structural member 10 without necessarily exposing the metal of the reinforcing structure 12 to the environment. The structural member 10 as shown in FIGS. 1 and 2 would be particularly useful for a structure requiring substantially planar vertical and horizontal surfaces, such as decking.

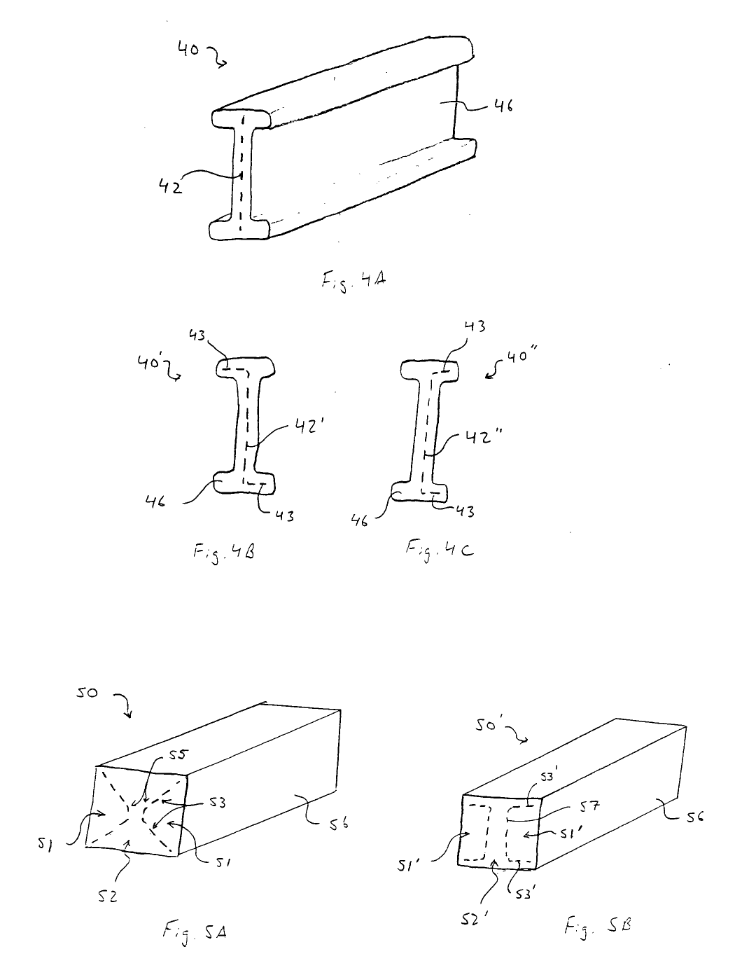

Another preferred embodiment of a reinforced structural member 30 according to the present invention is shown in FIG. 3. The structural member 30 shown in FIG. 3 differs from that embodiment previously discussed (FIGS. 1 and 2) in that the reinforcing structure 32 includes a pair of side walls 33 extending from the lateral edges of the reinforcing structure 32. The side walls 33 provide extra structural rigidity to the structural member 30. Preferably, the side walls 33 are disposed in a parallel fashion to the anticipated bending forces to which the structural member 30 may be subject. Again, the extruded exterior body 36 fully encapsulates the reinforcing structure 32.

FIG. 4A shows a preferred embodiment of a reinforced structural member 40 in which the exterior body 46 is extruded in the form of an I-beam. As shown, the reinforcing structure 42 is disposed along a longitudinal plane which divides the structural member 40 into substantially identical halves. Note, however, as shown in FIGS. 4B and 4C, alternate embodiments of the structural members 40′, 40″ are possible in which the reinforcing structures 42′, 42″ includes side walls 43. The side walls 43 may extend in an opposed fashion from the reinforcing structure 42′ (FIG. 4B) or may extend from the reinforcing structure 42″ (FIG. 4C) in the same direction. Note, the structural members may receive both holes and fasteners either through portions including the reinforcing structure or not including the reinforcing structure.

Preferred embodiments of reinforced structural members 50, 50′ are shown in FIGS. 5A and 5B, respectively. As shown in FIG. 5A, the reinforcing structure 52 includes a pair of reinforcing elements 51 that are V-shaped in cross section, each including a pair of side walls 53 meeting at an apex 55. The angled reinforcing elements 51 are disposed within the extruded exterior body 56 such that the apexes 55 of each sheet are disposed adjacent one another. FIG. 5B shows an alternate embodiment of the reinforcing structure 52′ within the structural member 50′. As shown, the reinforcing structure 52′ includes a pair of channeled reinforcing elements 51′ that are U-shaped in cross section, each having a central wall 57 and a pair of side walls 53′ extending from the central wall 57 along its lateral edges. The channeled elements are disposed within the extruded exterior body 56 such that the central wall portions are substantially parallel to and juxtaposed each other.

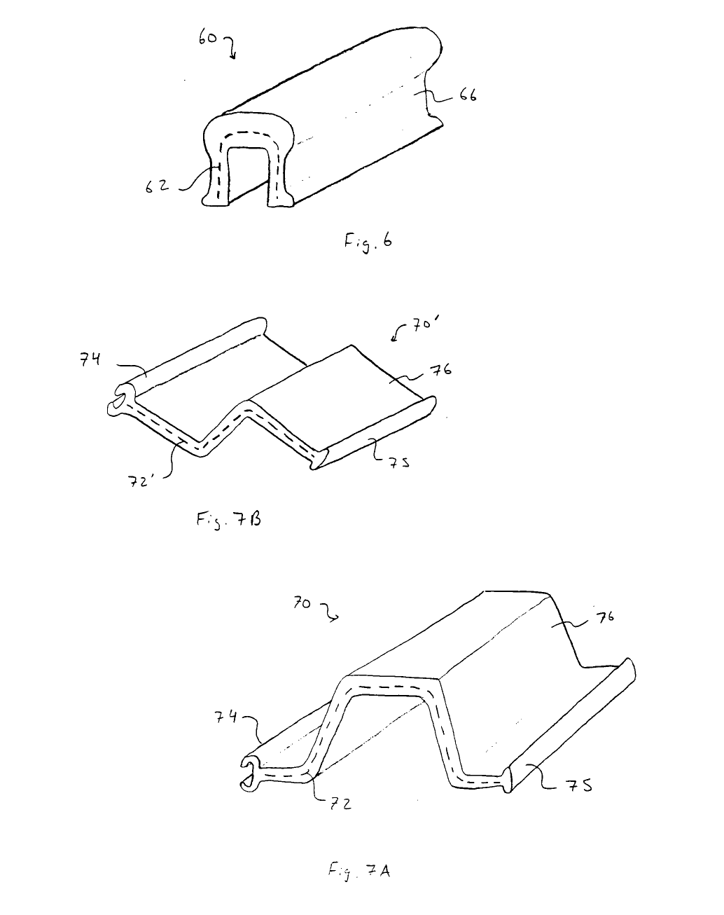

Another preferred embodiment of a reinforced structural member 60 according to the present invention is shown in FIG. 6. The structural member 60 includes a substantially U-shaped reinforcing structure 62 disposed within the exterior body 66. As shown, the exterior body 66 has been extruded in a shape specifically suited for use as a handrail.

FIG. 7A illustrates a reinforced structural member 70 as would be used in forming of a barrier wall, sea wall, or like structure. Typically, the structural members 70 extend vertically with lower ends received in the soil. The structural members 70 are joined in side edge to side edge relation and maintained in the desired position by an anchor system (not shown). Structural members 70 constructed in accordance with the present invention are particularly suited for such uses in that the foraminous reinforcing structure 72 lends structural rigidity to the structural member 70, yet remains protected from the external environmental conditions and corrosive elements by the exterior body 76 which is formed of water-impermeable material.

The exterior body 76 of the structural members 70 are extruded lengthwise about the foraminous reinforcing sheet so as to form a constant, uniform cross section from end-to-end. In the preferred embodiment shown, each structural member 70 includes a female C-shaped locking element 74 and a protruding male locking element 75 disposed at opposite lateral edges of the structural member 70. The female locking element 74 comprises a channel configured to slidably receive the male locking element 75 of a duplicate structural member. Preferably, the exterior body 76 is formed from water-impermeable plastics which exhibit resistance to abrasion and are therefore resistant to damage from pile driving and exposure to the environment. Typical thicknesses of the structural members 70 range from approximately 0.100 to 1.5 inches

FIG. 7B shows a perspective view of an alternate embodiment of a structural member 70′ according to the present invention that is suitable for forming sea walls, barrier walls, and like structures.

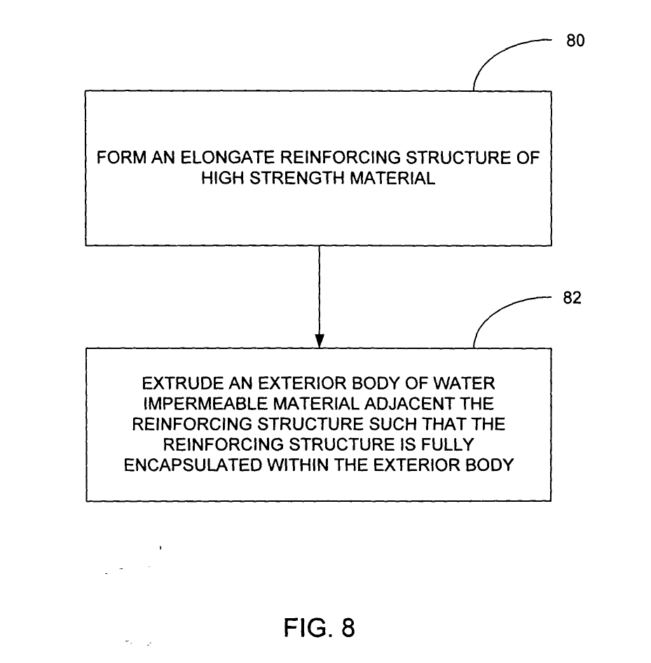

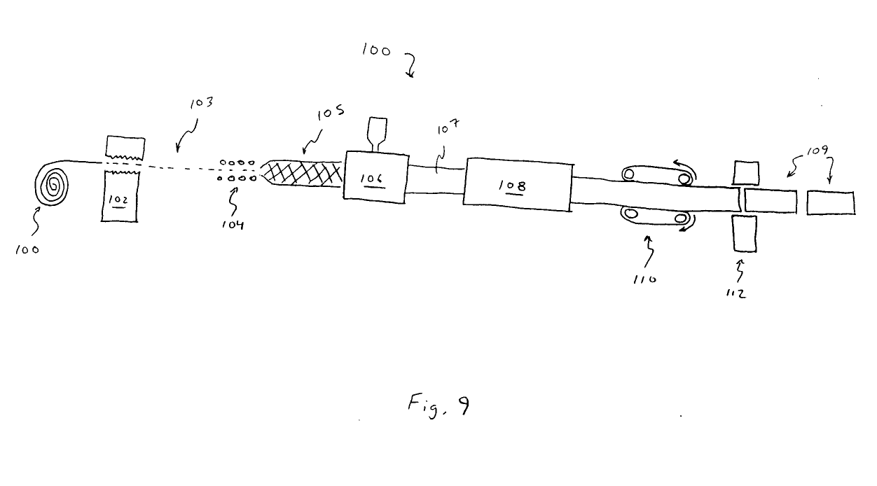

A preferred method of producing a reinforced structural member according to the present invention is shown in FIG. 8. As shown in step 80, an elongate reinforcing structure is preferably formed from expanded metal. Because the reinforcing structure is preferably formed from expanded metal, the reinforcing structure defines a plurality of perforations. As shown in step 82, an exterior body of water-impermeable material is formed adjacent the reinforcing structure such that the reinforcing structure is fully encapsulated within the exterior body. The exterior body is extruded in the cross sectional shape as is dictated by the type of structural member being produced, such as a plank, I-beam, etc., and the anticipated loads it will support.

A preferred embodiment of a system configured to form a reinforced structural member according to the present invention is shown in FIG. 9. As shown, metal from a coil 100, preferably galvanized steel, passes through an expander 102. After the expander 102, the now expanded metal 103 passes through a roll former 104 that forms the expanded metal 103 into the desired reinforcing structure 105. The reinforcing structure 105 next passes through a extrusion dye 106 where the exterior body 107 is extruded onto the reinforcing structure 105. The cooling tank 108 solidifies the exterior body 107 on the reinforcing structure 105, thereby forming the reinforced structured member 109. The puller 110 urges the continuous reinforced structural member through the system 100 and ultimately through a saw 112 that cuts the reinforced structural member to the desired lengths. Note, the process need not be continuous, reinforced structural members can be constructed using batch processing. As well, the noted steps can be manually performed.

The reinforcing structure has been described as being formed of expanded material, such as expanded metal. However, the reinforcing structure can be formed of material that has an array of perforations formed there through by other manufacturing procedures.

The reinforcing structure of all of the embodiments of the invention extend substantially the entire lengths of the structural members so that the longitudinal loads applied to one end of the structural members can be transmitted through the reinforcing structure from one end to the other end of the structural members.

Also, the reinforcing member extends substantially across the entire width of the structural member and into the non-planar shapes of the structural member so as to provide strength in three dimensions of the structural member.

Preferably, the reinforcing structure is completely enveloped within the exterior body so that the reinforcing member is sealed from the environment; however, it might be desirable to cut the structural member to a shorter length that exposes a cross section of the reinforcing structure, thus exposing the edges of the reinforcing structure. But this exposes only a small amount of the metal reinforcing structure and the exposed portion is separated from other portions of the structure by the holes formed in the structure, thereby minimizing the exposure of the reinforcing structure to the surrounding environment and limiting the tendency of rust and corrosion forming on the reinforcing structure.

The foregoing description has been presented for purposes of illustration and description. It is not intended to be exhaustive or to limit the invention to the precise forms disclosed. Obvious modifications or variations are possible in light of the above teachings. The embodiment or embodiments discussed were chosen to provide the best illustration of the principles of the invention and its practical application and to thereby enable one of ordinary skill in the art to utilize the invention and various embodiments with various modifications as are suited to the particular use contemplated. All such modifications and variations are within the scope of the invention as determined by the appended claims when interpreted in accordance with the breath to which they are fairly and legally entitled.

1. A method of producing a reinforced structural member comprising the steps of:
providing an elongate reinforcing structure of foraminous high strength material defining an array of openings therethrough;
extruding an exterior body of water-impermeable material about and into contact with said reinforcing structure;
encapsulating said reinforcing structure within said exterior body, and curing the exterior body.

2. The method of claim 1, wherein the step of extruding an exterior body of water-impermeable material about said reinforcing structure comprises urging the water-impermeable material through the holes of the foraminous material.

3. The method of claim 1, wherein said forming step further comprises forming a substantially planar elongate central wall and a pair of side walls extending along opposed lateral edges of said central wall.

4. The method of claim 3, wherein each said side wall is substantially perpendicular to said central wall and substantially parallel to other said side wall.

5. The method of claim 4, wherein said extruding step further comprises extruding said exterior body such that said exterior body is substantially I-shaped in cross section.

6. The method of claim 4, wherein said side walls both extend from said central wall in the same direction.

7. The method of claim 1, wherein:
said extruding step further comprises extruding said exterior body such that said exterior body is substantially I-shaped in cross section; and
said reinforcing structure is substantially planar and is disposed along a longitudinal plane of said exterior body.

8. The method of claim 1, wherein:
said forming step further comprises forming a first and a second angled element, each said first and second angled elements including a pair of walls that intersect at an apex, said apexes being disposed adjacent each other; and
said extruding step further comprises extruding said exterior body such that said exterior body is substantially square in cross section.

9. The method of claim 1, wherein:
said forming step further comprises forming a first and a second channeled element, each said first and second channeled elements including a substantially planar central wall and a pair of parallel side walls extending perpendicularly therefrom, said central walls being juxtaposed each other; and
said extruding step further comprises extruding said exterior body in a substantially square cross section shape.

10. The method of claim 1, wherein:
said forming step further comprises forming said reinforcing structure such that said reinforcing structure is U-shaped in cross section; and
said extruding step further comprises forming said exterior body such that said exterior body is U-shaped in cross section.

11. The method of claim 1, wherein:
said forming step further comprises forming said reinforcing structure such that said reinforcing structure includes a plurality of planar sections and a pair of lateral edges; and
said extruding step further comprises extruding a male interlocking connector and a female interlocking connector on opposite of said opposed lateral edges, said male and female interlocking connectors configured to be slidably engage.

12. The method of claim 1, wherein said providing step further comprises providing an elongate reinforcing structure of steel.

13. The method of claim 1, wherein said providing step further comprises providing an elongate reinforcing structure of fiberglass.

14. A reinforced structural member comprising:
an elongate reinforcing structure formed of high strength material defining an array of equally spaced openings therethrough;
an exterior body of water-impermeable material positioned about and in contact with said reinforcing structure; and
wherein said reinforcing structure is encapsulated within said exterior body.

15. The reinforced structural member of claim 14, wherein said reinforcing structure is comprised of steel and has a thickness from approximately 0.010 to 0.750 inches.

16. The structural member of claim 15, wherein said reinforcing structure further comprises a substantially planar elongate central wall and a pair of side walls extending along opposed lateral edges of said central wall.

17. The structural member of claim 16, wherein each said side wall is substantially perpendicular to said central wall and substantially parallel to other said side wall.

18. The structural member of claim 17, wherein said exterior body is substantially I-shaped in cross section.

19. The structural member of claim 17, wherein said side walls both extend from said central wall in the same direction.

20. The structural member of claim 14, wherein:
said exterior body is substantially I-shaped in cross section; and
said reinforcing structure is substantially planar and is disposed along a longitudinal plane of said exterior body.

21. The structural member of claim 14, wherein:
said reinforcing structure includes a first and a second angled element, each said first and second angled elements including a pair of walls that intersect at an apex, said apexes being disposed adjacent each other; and
said exterior body such that said exterior body is substantially square in cross section.

22. The structural member of claim 14, wherein:
said reinforcing structure includes a first and a second channeled element, each said first and second channeled elements including a substantially planar central wall and a pair of parallel side walls extending perpendicularly therefrom, said central walls being disposed parallel to each other; and
said exterior body is substantially square in cross section.

23. The structural member of claim 14, wherein:
said reinforcing structure is U-shaped in cross section; and
said exterior body is U-shaped in cross section.

24. The structural member of claim 14, wherein:
said reinforcing structure includes a plurality of planar sections and a pair of lateral edges; and
said exterior body includes a male interlocking connector and a female interlocking connector on opposite of said opposed lateral edges, said male and female interlocking connectors configured to be slidably engaged.

25. The structural member of claim 14, wherein said high strength material is selected from the group consisting of: steel, galvanized steel and aluminum.

26. The structural member of claim 14, wherein said high strength material is fiberglass.

27. An elongated reinforced structural member suitable for being driven into the ground, comprising:
an elongated reinforcing structure formed of high strength material defining an open network of openings there through,
an exterior body of water-impermeable synthetic material surrounding said reinforcing structure, said exterior body locked to said reinforcing structure by extending through said openings of said reinforcing structure,
said exterior body having a length, a width and a thickness,
said reinforcing structure extending along substantially the entire length of said exterior body and substantially along the entire width of said exterior body for providing an impact area at the ends of the structural member for receiving impacts during the driving of the structural member into the ground,
said reinforcing structure being of greater tensile and compressive strength than said exterior body, so that the longitudinal forces received at an end of said structural member are transmitted through said reinforcing structure from one end to the other end of the reinforcing structure.

28. The structural member of claim 27, wherein said reinforcing structure comprises expanded sheet metal, and said exterior body is characterized by having been extruded onto said reinforcing structure.

29. The structural member of claim 27, wherein the holes in said reinforcing structure retards the spread of rust and corrosion of said reinforcing structure.
